(19) United States
(12) Patent Application Publication
(10) Pub. No.: US 2007/0002712 A1
(43) Pub. Date: Jan. 4, 2007

(54) Unbalanced disc detection and rotating speed control in disc reading apparatus

(75) Inventors: Fu-Hsiang Chen, Hsinchu (TW); Ren-Te Lin, Hsinchu (TW); Hsiang-Yi Fu, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/064,047

(22) Filed: Feb. 23, 2005

(30) Foreign Application Priority Data
Mar. 2, 2004 (TW) 093105434

(51) Int. Cl. G11B 27/36

(52) U.S. Cl. 369/53.41

(57) ABSTRACT

A method for detecting an unbalanced disc in a disc reading apparatus includes the following steps. Firstly, a disc is loaded into the disc reading apparatus. Then, a start-up procedure is performed at a first rotating speed. After the start-up procedure is completed, the disc reading apparatus enters a ready-to-read state. In the ready-to-read state, an unbalanced disc detection procedure is performed by detecting a vibration degree of the disc at a second rotating speed greater than the first rotating speed. Afterward, it is determined whether the disc is an unbalanced disc according to the vibration degree of the disc.

### FIELD OF THE INVENTION

The present invention relates to a method for detecting whether the disc reading apparatus is reading an unbalanced disc, and more particularly further controlling a rotating speed of the unbalanced disc in the disc reading apparatus.

### BACKGROUND OF THE INVENTION

Optical discs such as compact discs (CDs), video compact discs (VCDs) and digital versatile disc (DVDs) are able to be played by recording and reproducing apparatuses. When an optical pickup head of an optical disc drive operates, the light emitted by a light source such as a laser diode is focused by an object lens of the optical pickup head on an optical disc, and the light reflected by the optical disc is transmitted to a light sensor to reproduce information from the disc. Referring to FIG. 1, the optical pickup head 10 moves along two main directions, i.e. a direction perpendicular to the disc plate, referred as a focusing direction F, and a direction parallel to the disc plate, referred as a tracking direction T. Typically, after an optical disc is loaded into the optical disc drive, a start-up procedure is entered. In the start-up procedure, the spindle motor rotates at the minimum rotating speed to rotate the disc at a slow constant speed. Meanwhile, the type of the disc is firstly identified, the voltage level of a radio frequency signal RF generated in response to an optical signal reflected from the disc is calibrated, and a table of contents (TOC) of the disc is read.

With the increasing development of optical reading techniques, high rotating speed for access to the disc data in the optical disc at high data transfer rate becomes essential. Unfortunately, some defects resulting from the manufacturing or storage process may occur in some disc products. One of the defects is the unbalance of the optical disc. In general, unbalance of an optical disc will cause non-uniform weight distribution and/or poor smoothness of the optical disc. Therefore, when the disc is rotated at a high rotating speed, severe vibration is likely to occur so that the disc may shift up and down along the focusing direction perpendicular to the disc plate. It is apparent that severe vibration may adversely influence the focusing performance of the optical pickup head, and thus results in inferior data pickup performance.

For alleviating the influence caused by the unbalance of the disc, an unbalanced disc detection procedure is incorporated into the start-up procedure to detect the vibration degree of the disc loaded in the optical disc drive. After the start-up and the unbalanced disc detection procedures are completed, then a ready-to-read state is entered. For reading data from the disc, the optical disc drive is operated at one of the preset speeds, which is selected for operation according to the vibration degree of the disc. For example, three different data transfer rates, e.g. 24×, 15× and 10×, are preset. The “1×” of speed is refer to about 150 k Bytes of data transferred per second. And for a higher data transfer rate, a higher rotating speed corresponding to the data transfer rate is needed. A disc vibrating at a low level determined in the unbalanced disc detection procedure is deemed as a normal disc, and thus rotated at the maximum speed corresponding to 24× in the following reading procedure performed in the ready-to-read state. A disc vibrating at a medium or high level is deemed as an unbalanced disc. The unbalanced disc should be operated at a lower speed in order to reduce the vibration effect. Depending on vibration degrees determined in the unbalanced disc detection procedure, different rotating speeds are selected for the following reading procedure. For example, for the medium vibration level, the 15× data transfer rate is adapted such that the rotating speed is reduced. On the other hand, for a high vibration level, it is preferred to further reduce the minimum rotating speed corresponding to 10×.

If no unbalanced disc detection procedure is utilized, the start-up procedure for aforementioned disc-identification, DC-level calibration and TOC-reading can be carried out at a minimum rotating speed. For performing the additional unbalanced disc detection procedure, however, the rotating speed has to be raised to a high level in order to practically realize the vibration degree of the disc. It typically takes 2˜3 seconds to speed the spindle motor up from the minimum rotating speed for the start-up procedure to a rotating speed high enough for unbalanced disc detection procedure. Since the combined start-up procedure is elongated, users have to wait a long time before the drive entering the ready-to-read state for them to access the disc.

### SUMMARY OF THE INVENTION

The present invention provides a method for detecting whether the loaded disc is an unbalanced disc at a proper stage so as to save operation time. Further, the rotating speeds are well and differentially controlled for normal and unbalanced discs, respectively.

In accordance with a first aspect of the present invention, there is provided a method for detecting an unbalanced disc in a disc reading apparatus. Firstly, a disc is loaded into the disc reading apparatus. Then, a start-up procedure is performed at a first rotating speed. After the start-up procedure is completed, the disc reading apparatus enters a ready-to-read state. In the ready-to-read state, an unbalanced disc detection procedure is performed by detecting a vibration degree of the disc at a second rotating speed greater than the first rotating speed. Afterward, it is determined whether the disc is an unbalanced disc according to the vibration degree of the disc.

In an embodiment, the vibration degree of the disc is detected by entering a tracking-off state to read the disc at the second rotating speed from a fixed position to obtain an unbalance detection signal, and operating the unbalance detection signal to realize the variation degree.

In an embodiment, the unbalance detection signal is a tracking error signal, and the unbalance detection signal is operated by an integration operation. Whether the disc is an unbalanced disc is determined by comparing a result of the integration operation for one cycle revolution of the disc with a threshold value.

In an embodiment, the unbalance detection signal is a tracking error zero cross (TEZC) signal, and the unbalance detection signal is operated by a counting operation of TEZC points in the TEZC signal. Whether the disc is an unbalanced disc is determined by comparing a result of the counting operation for one cycle revolution of the disc with a threshold value.

In accordance with a second aspect of the present invention, there is provided a method for detecting an unbalanced disc in a disc reading apparatus. Firstly, a disc is loaded into the disc reading apparatus. Then, a start-up procedure is performed at a first rotating speed. After the start-up procedure is completed, the disc reading apparatus enters a ready-to-read state. In the ready-to-read state, a first unbalanced disc detection procedure is performed by detecting a first vibration degree of the disc at a second rotating speed greater than the first rotating speed, and determining whether the disc is an unbalanced disc according to the first vibration degree of the disc. Afterward, a second unbalanced disc detection procedure is performed in the ready-to-read state by detecting a second vibration degree of the disc at a third rotating speed greater than the second rotating speed when the disc is determined not to be an unbalanced disc in the first unbalanced disc detection procedure, and further determining whether the disc is an unbalanced disc according to the second vibration degree of the disc.

In an embodiment, the detection step of each of the first and second vibration degrees comprises steps of entering a tracking-off state to read the disc from a fixed position to obtain an unbalance detection signal, and operating the unbalance detection signal to realize the variation degree.

In accordance with a third aspect of the present invention, there is provided a method for rotating speed control in a disc reading apparatus. Firstly, a disc is loaded into the disc reading apparatus. Then, a start-up procedure is performed at a first rotating speed of the disc. After the start-up procedure is completed, the disc reading apparatus enters a ready-to-read state. In the ready-to-read state, a first unbalanced disc detection procedure is performed at a second rotating speed of the disc greater than the first rotating speed. Then, a reading procedure is performed at a third rotating speed of the disc less than the second rotating speed when the disc is determined to be an unbalanced disc in the first unbalanced disc detection procedure. Afterward, the revolution of the disc can be speeded up from the second rotating speed to a fourth rotating speed when the disc is determined not to be an unbalanced disc in the first unbalanced disc detection procedure.

In an embodiment, the method further comprises steps of performing a second unbalanced disc detection procedure at the fourth rotating revolving speed of the disc, performing a reading procedure at a fifth rotating speed of the disc less than the fourth rotating speed when the disc is determined to be an unbalanced disc in the second unbalanced disc detection procedure. The revolution of the disc can be speeded up from the fourth rotating speed to a six rotating speed when the disc is determined not to be an unbalanced disc in the second unbalanced disc detection procedure. In an embodiment, the fifth rotating speed is greater than or equal to the third rotating speed.

In an embodiment, at least one of the first and second unbalanced disc detection procedures comprises steps of entering a tracking-off state to read, the disc from a fixed position to obtain an unbalance detection signal, operating the unbalance detection signal to realize a variation degree, and determining whether the disc is an unbalanced disc according to the vibration degree.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic diagram illustrating a typical optical pickup head in a disc drive;

FIG. 2 is a flowchart illustrating a process for detecting an unbalanced disc in a slim-type CD drive for use in a notebook computer according to a preferred embodiment of the present invention; and

FIGS. 3(a), 3(b) and 3(c) illustrate three timing diagrams of the rotating speed controlled in different stages for three situations.

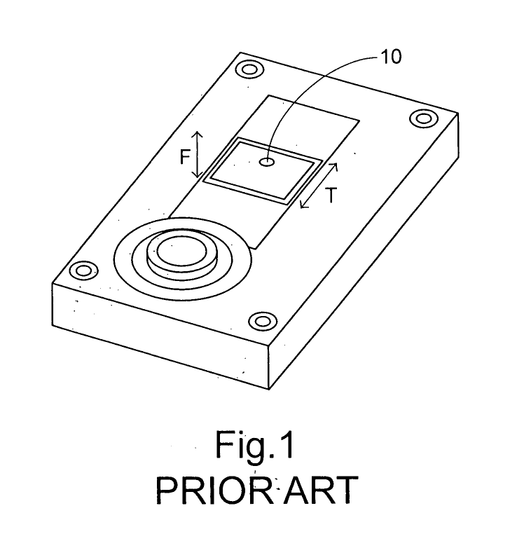

### DETAILED DESCRIPTION OF THE PREFERRED EMBODIMENT

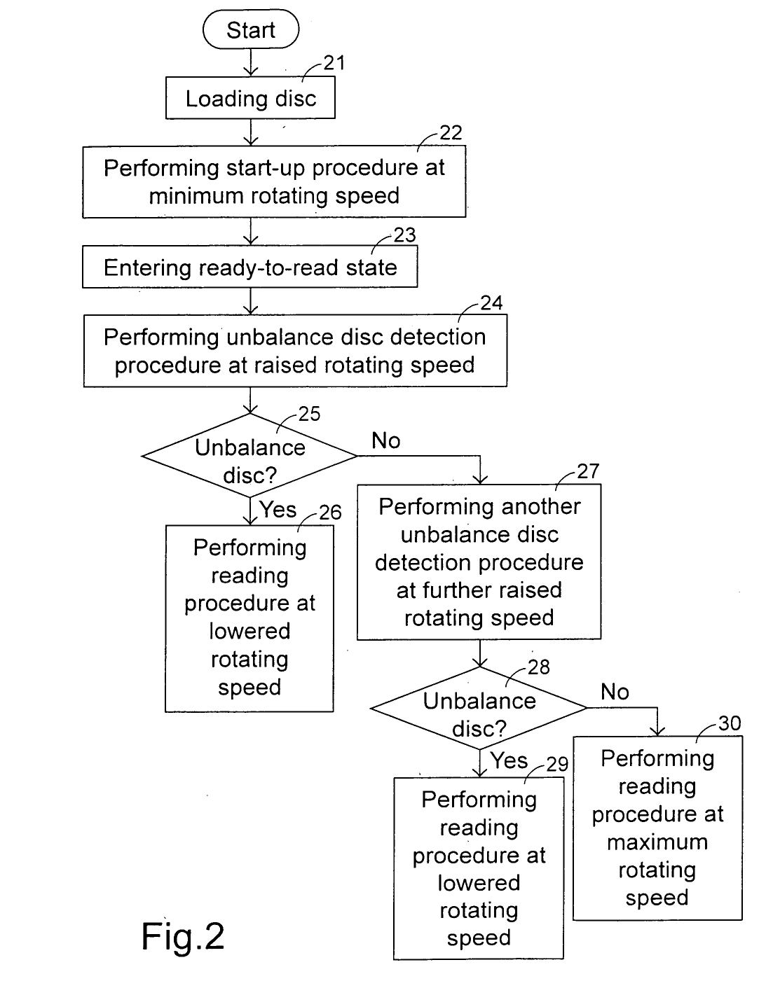

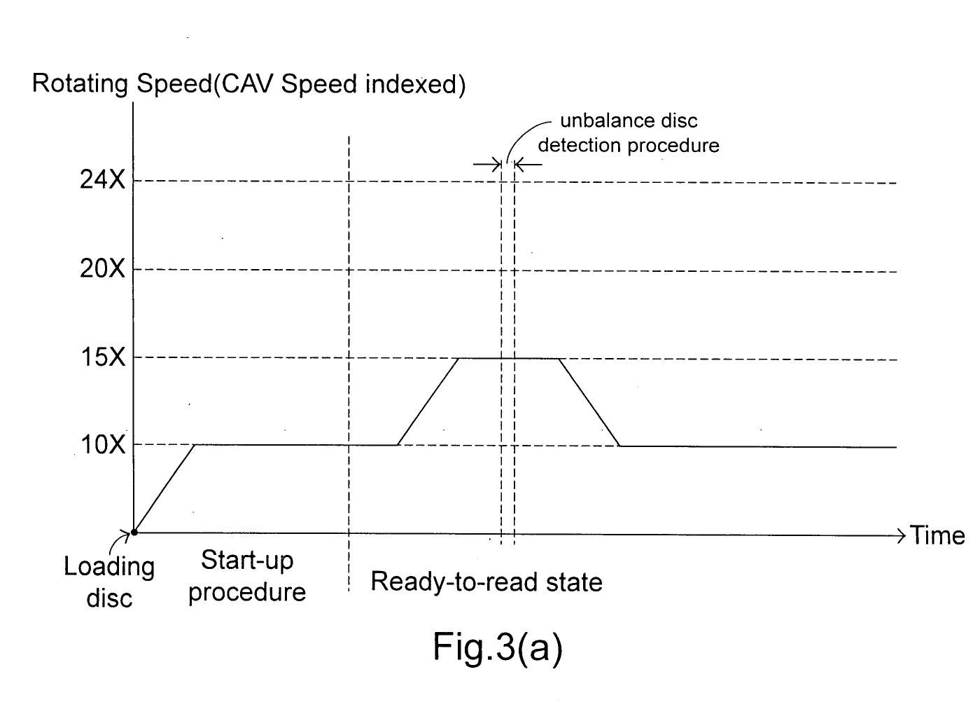

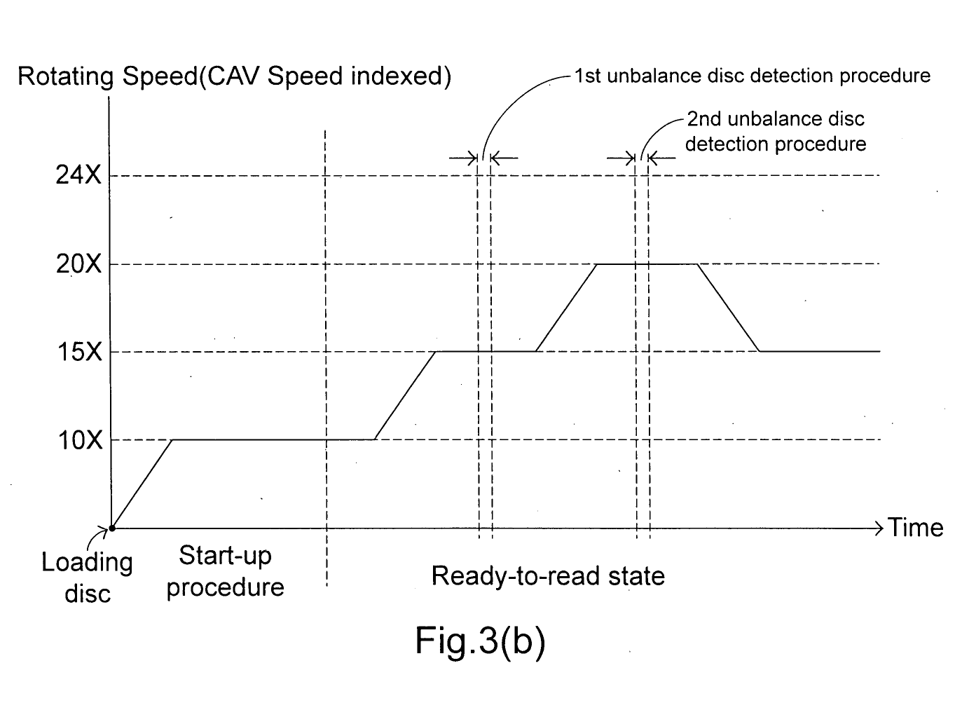

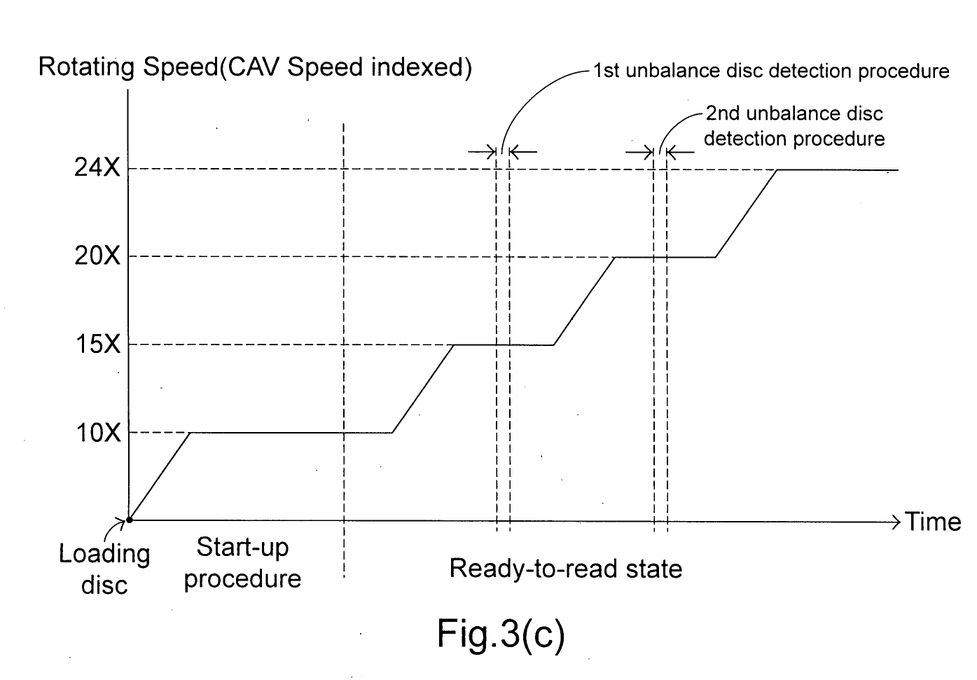

Depending on the type of the disc drive, the maximum and minimum rotating speeds vary. Hereinafter, the process for detecting an unbalanced disc in a disc reading apparatus such as slim-type CD drive operated between 24× Constant Angular Velocity (CAV) reading (maximum) and 10× CAV reading (minimum) for use in a notebook computer according to a preferred embodiment of the present invention is illustrated with reference to the flowchart of FIG. 2 and the timing plot of FIG. 3.

After an optical disc is loaded into the CD drive (Step 21), a start-up procedure is entered (Step 22). In the start-up procedure, the spindle motor rotates at the minimum rotating speed, e.g. the rotating speed corresponding to 10× CAV reading, to rotate the disc at a slow constant rotating speed. Meanwhile, the type of the disc is firstly identified, the voltage level of a radio frequency signal RF generated in response to an optical signal reflected from the disc is calibrated, and a table of contents (TOC) of the disc is read. After the start-up procedure is completed, a ready-to-read state is entered (Step 23). No unbalanced disc detection procedure is performed during this stage.

After entering the ready-to-read state, the rotating speed is raised to for example the speed corresponding to 15× CAV reading, and an unbalanced disc detection procedure is performed at such rotating speed higher than the minimum rotating speed (Step 24) to practically realize the vibration degree of the disc. In the unbalanced disc detection procedure, whether the disc is an unbalanced disc is determined according to the vibration degree of the disc (Step 25). For detecting the vibration degree, the CD drive enters a tracking-off state. In the tracking-off state, the optical pickup head of the CD drive is located at a fixed position to read the disc and obtain a tracking error (TE) signal. In this embodiment, the tracking error (TE) signal is used as an unbalance detection signal to detect the vibration degree. For example, an integration value of absolute value of the tracking error (TE) signal calculated in one cycle of revolution at the constant rotating speed corresponding to 15× CAV reading inherently represents the variation degree. If the integration value is greater than a threshold value, the disc is deemed as an unbalanced disc. Therefore, the rotating speed for the following reading procedure of this unbalanced disc is fixed at a low level, e.g. the rotating speed corresponding to 10× CAV reading (Step 26). The exemplified timing plot up to this stage is shown in FIG. 3(a). Instead of the tracking error (TE) signal, a tracking error zero cross (TEZC) signal derived from the TE signal can also be used to detect the vibration degree. For example, if the TEZC points represented by the TEZC signal calculated in one cycle of revolution at the constant rotating speed corresponding to 15× CAV reading are greater than a predetermined number, the disc is deemed as an unbalanced disc.

On the other hand, if the disc is determined not to be an unbalanced disc in the unbalanced disc detection procedure (Step 25), another unbalanced disc detection procedure is performed at another stage in the ready-to-read state where the rotating speed is further raised to a higher level, e.g. the speed corresponding to 20× CAV reading, to determine whether the disc is an unbalanced disc according to the vibration degree of the disc (Step 27). Likewise, a TE signal or TEZC signal can be referred to detect the vibration degree and determine whether the disc is an unbalanced disc. If the disc is determined to be an unbalanced disc in this unbalanced disc detection procedure (Step 28), this unbalanced disc is fixed at a low level, e.g. the speed corresponding to 15× (or 10×) CAV reading (Step 29). The exemplified timing plot of the revolving speed controlled up to this stage is shown in FIG. 3(b). Otherwise, if the disc is determined not to be an unbalanced disc, the revolution of the disc can work under 20× or be further speeded up, for example to the maximum rotating speed (the speed corresponding to 24×) of the spindle motor to perform the following reading procedure (Step 30). The timing plot in this case is shown in FIG. 3(c).

Since the unbalanced disc detection procedure(s) is/are performed in the ready-to-read state, the entire period for performing the start-up procedure can be minimized, which is in general about 8˜10 seconds so as to save about 2˜3 seconds compared to the conventional start-up procedure with unbalance disc detection procedure. On the other hand, it takes only about 0.3 second to perform the unbalanced disc detection procedure at the raised rotating speed in the ready-to-read state. Accordingly, a suitable rotating speed of the disc for executing the reading procedure can be quickly determined. Further, according to the present invention, one or more unbalanced disc detection procedures may be suitable. In such manner, the vibration degrees at different rotating speeds can be precisely detected so as to obtain an optimum rotating speed of the disc in the following reading procedure.

In the above embodiments, the disc reading apparatus is exemplified as a slim-type CD drive. Alternatively, the disc reading apparatus can also be a slim-type DVD drive, a CD-RW drive, a DVD-RW drive or any other suitable disc reading apparatus suffering from unbalance of discs. It is understood from the above description that the method of the present invention is effective for detecting whether the loaded disc is an unbalanced disc at a proper stage so as to save operation time. Further, the rotating speeds are well and differentially controlled for normal and unbalanced discs, respectively.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for detecting an unbalanced disc in a disc reading apparatus, comprising steps of:
loading a disc into said disc reading apparatus;
performing a start-up procedure at a first rotating speed;
entering a ready-to-read state after said start-up procedure is completed;
performing an unbalanced disc detection procedure in said ready-to-read state by detecting a vibration degree of said disc at a second rotating speed greater than said first rotating speed; and
determining whether said disc is an unbalanced disc according to said vibration degree of said disc.

2. The method according to claim 1 wherein said vibration degree of said disc is detected by entering a tracking-off state to read said disc at said second rotating speed from a fixed position to obtain an unbalance detection signal, and operating said unbalance detection signal to realize said variation degree.

3. The method according to claim 2 wherein said unbalance detection signal is a tracking error signal, and said unbalance detection signal is operated by an integration operation.

4. The method according to claim 3 wherein whether said disc is an unbalanced disc is determined by comparing a result of said integration operation for one cycle revolution of said disc with a threshold value.

5. The method according to claim 2 wherein said unbalance detection signal is a tracking error zero cross (TEZC) signal, and said unbalance detection signal is operated by a counting operation of TEZC points in said TEZC signal.

6. The method according to claim 5 wherein whether said disc is an unbalanced disc is determined by comparing a result of said counting operation for one cycle revolution of said disc with a threshold value.

7. A method for detecting an unbalanced disc in a disc reading apparatus, comprising steps of:
loading a disc into said disc reading apparatus;
performing a start-up procedure at a first rotating speed;
entering a ready-to-read state after said start-up procedure is completed;
performing a first unbalanced disc detection procedure in said ready-to-read state by detecting a first vibration degree of said disc at a second rotating speed greater than said first rotating speed, and determining whether said disc is an unbalanced disc according to said first vibration degree of said disc; and
performing a second unbalanced disc detection procedure in said ready-to-read state by detecting a second vibration degree of said disc at a third rotating speed greater than said second rotating speed when said disc is determined not to be an unbalanced disc in said first unbalanced disc detection procedure, and further determining whether said disc is an unbalanced disc according to said second vibration degree of said disc.

8. The method according to claim 7 wherein the detection step of each of said first and second vibration degrees comprises steps of entering a tracking-off state to read said disc from a fixed position to obtain an unbalance detection signal, and operating said unbalance detection signal to realize said variation degree.

9. The method according to claim 8 wherein said unbalance detection signal is a tracking error signal, and said unbalance detection signal is operated by an integration operation.

10. The method according to claim 9 wherein whether said disc is an unbalanced disc is determined in each of said first and second unbalanced disc detection procedures by comparing a result of said integration operation for one cycle revolution of said disc with a threshold value.

11. The method according to claim 8 wherein said unbalance detection signal is a tracking error zero cross (TEZC) signal, and said unbalance detection signal is operated by a counting operation of TEZC points in said TEZC signal.

12. The method according to claim 11 wherein whether said disc is an unbalanced disc is determined in each of said first and second unbalanced disc detection procedures by comparing a result of said counting operation for one cycle revolution of said disc with a threshold value.

13. A method for revolving speed control in a disc reading apparatus, comprising steps of:
loading a disc into said disc reading apparatus;
performing a start-up procedure at a first rotating speed of said disc;
entering a ready-to-read state after said start-up procedure is completed;
performing a first unbalanced disc detection procedure in said ready-to-read state at a second rotating speed of said disc greater than said first rotating speed; and
performing a reading procedure at a third rotating speed of said disc less than said second rotating speed when said disc is determined to be an unbalanced disc in said first unbalanced disc detection procedure.

14. The method according to claim 13 further comprising steps of:
speeding the revolution of said disc up from said second rotating speed to a fourth rotating speed when said disc is determined not to be an unbalanced disc in said first unbalanced disc detection procedure;
performing a second unbalanced disc detection procedure at said fourth rotating speed of said disc; and
performing a reading procedure at a fifth rotating speed of said disc less than said fourth rotating speed when said disc is determined to be an unbalanced disc in said second unbalanced disc detection procedure.

15. The method according to claim 14 further comprising steps of:
speeding the revolution of said disc up from said fourth rotating speed to a six rotating speed when said disc is determined not to be an unbalanced disc in said second unbalanced disc detection procedure; and
performing a reading procedure at said sixth rotating speed of said disc.

16. The method according to claim 14 wherein said fifth rotating speed is greater than or equal to said third rotating speed.

17. The method according to claim 14 wherein at least one of said first and second unbalanced disc detection procedures comprises steps of:
entering a tracking-off state to read said disc from a fixed position to obtain an unbalance detection signal;
operating said unbalance detection signal to realize a variation degree; and
determining whether said disc is an unbalanced disc according to said vibration degree.

18. The method according to claim 17 wherein said unbalance detection signal is a tracking error signal, said unbalance detection signal is operated by an integration operation, and whether said disc is an unbalanced disc is determined by comparing a result of said integration operation with a threshold value.

19. The method according to claim 17 wherein said unbalance detection signal is a tracking error zero cross (TEZC) signal, said unbalance detection signal is operated by a counting operation of TEZC points in said TEZC signal, and whether said disc is an unbalanced disc is determined by comparing a result of said counting operation with a threshold value.

20. The method according to claim 13 wherein each of said first and third rotating speeds is the minimum rotating speed of said disc reading apparatus.
